(19) United States
(12) Patent Application Publication
(10) Pub. No.: US 2006/0109281 A1
(43) Pub. Date: May 25, 2006

(54) Video display apparatus

(75) Inventor: Junji Kotani, Kawasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/267,546

(22) Filed: Nov. 4, 2005

(30) Foreign Application Priority Data
Nov. 24, 2004 (JP) 2004-338925

(51) Int. Cl. G09G 5/00

(52) U.S. Cl. 345/617

(57) ABSTRACT

At least one exemplary embodiment is directed to a video display apparatus that can use a controller to calculate a correction value and determine the sampling clock to improve the accuracy of a correction clock, where the correction clock can be used for error reduction, so that degradation of the contrast can be reduced.

### BACKGROUND OF THE INVENTION

1. Field of the Invention

The present invention relates to a video display.

2. Description of the Related Art

In a video display apparatus (e.g., a liquid crystal projector), analog video signals received from a personal computer (PC) are converted into digital video signals by an A/D converter, and the digital video signals are changed, by digital processing, into an appropriate form for displaying.

As part of the digital processing, the adjustment of brightness or contrast, for example, keystone correction and gamma correction are performed.

Thereafter, in the liquid crystal projector, a light valve is controlled by using the obtained digital video signals, and as a result, light emitted by a source lamp is modulated to project pictures.

For such a system, an analog video signal should be correctly converted into a digital video signal.

That is, the black level and the white level values for the analog signal should be discrete values that correspond correctly to the black and white levels of a digital signal. When a correct conversion is not performed, saturation is improperly adjusted and a picture of good quality is not displayed.

There are various analog video signals having different vertical/horizontal frequencies and various vertical/horizontal resolutions, and the sampling speeds for A/D conversion are also different. Therefore, to obtain and to output a correct picture, an A/D converter is used, of which output is constant despite of the different sampling clocks employed.

Otherwise the quality of displayed picture can be reduced.

### SUMMARY OF THE INVENTION

At least one exemplary embodiment is directed to a video display apparatus that can provide an appropriate picture at a desired resolution, even when an A/D converter such as the one described above is employed.

In at least one exemplary embodiment, when determining the sampling clock, the controller also calculates a correction value.

In at least one exemplary embodiment, even when an A/D converter having an inadequate sampling clock characteristic is employed, the output of a picture affected by the difference of resolution is reduced, and an appropriate picture can be obtained.

Further features of the present invention will become apparent from the following description of exemplary embodiments (with reference to the attached drawings).

### BRIEF DESCRIPTION OF THE DRAWINGS

FIG. 1 illustrates a block diagram showing a video display apparatus of the first exemplary embodiment;

FIG. 2 illustrates a diagram showing a memory map for an NVRAM;

FIG. 3 illustrates a diagram showing an example picture displayed on the video display apparatus in accordance with the first exemplary embodiment;

FIG. 4 illustrates a flowchart showing an analog RGB signal detection process sequence performed in the first exemplary embodiment;

FIG. 5 illustrates a table for signal forms stored in a ROM;

FIG. 6 illustrates a correction table stored in the ROM; and

FIG. 7 illustrates a flowchart showing an analog RGB signal detection process sequence performed in the second exemplary embodiment

### DESCRIPTION OF THE EMBODIMENTS

The following description of exemplary embodiment(s) is/are merely illustrative in nature and is in no way intended to limit the invention, its application, or uses.

Processes, techniques, apparatus, and materials as known by one of ordinary skill in the art can not be discussed in detail but are intended to be part of the enabling description where appropriate. For example, certain circuitry for a matrix operating circuit, a light valve drive circuit, and others can not be discussed in detail. However these systems and the methods to fabricate these system as known by one of ordinary skill in the relevant art is intended to be part of the enabling disclosure herein where appropriate.

Note that similar reference numerals and letters refer to similar items in the following figures, and thus once an item is defined in one figure, it can not be discussed for following figures.

The exemplary embodiments can be used with many different types of display systems (e.g., video display apparatus). The non-limiting examples described below refer to a video display apparatus. However exemplary embodiments can be used for a variety of display systems and thus are not limited to video display apparatus.

### First Exemplary Embodiment

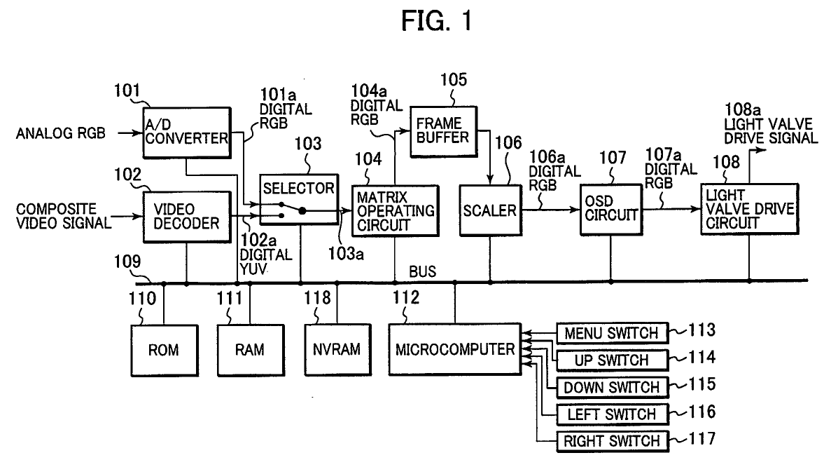

FIG. 1 illustrates a block circuit diagram showing the configuration of a video display apparatus (e.g., liquid crystal projector) of a first exemplary embodiment.

A digital RGB video signal 101a output terminal of an A/D converter 101 and the digital YUV video signal 102a output terminal of a video decoder 102 are connected to a selector 103. The selector 103 selectively transmits the signal 101a output by the A/D converter 101 or the signal 102a output by the video decoder 102 to a matrix operating circuit 104.

A digital RGB video signal 104a, which is the output of the matrix operating circuit 104, is transmitted to a scaler 106 through a frame buffer 105 that is used to store digital RGB video signals for one frame.

A digital RGB video signal 106a, which is output by the scaler 106, is transmitted through an OSD (On Screen Display) circuit 107 to 107a a light valve drive circuit 108.

The light valve drive circuit 108 outputs a light valve drive signal 108a to permit a light valve (not shown) to form an input picture.

The A/D converter 101, the video decoder 102, the selector 103, the matrix operating circuit 104, the scaler 106, the OSD circuit 107 and the light valve drive circuit 108 are connected to a bus 109.

A micro computer 112 (e.g., a processor), a RAM 111, a ROM 110 and an NVRAM (nonvolatile memory) 118 are also connected to the bus 109.

Provided in the RAM 111 are a stack, for the operation of the micro computer 112, and a work area.

Provided in the ROM 110 are a program, for operating the micro computer 112, and a data area.

And stored in the NVRAM (nonvolatile memory) 118, even when power is not supplied to the video display apparatus (e.g., liquid crystal projector), are data included for a setup related to the operation of the video display apparatus (e.g., liquid crystal projector) and for a setup for a menu screen.

A MENU switch 113, an UP switch 114, a DOWN switch 115, a LEFT switch 116 and a RIGHT switch 117 are connected to the micro computer 112.

The MENU switch 113 can be used for entering an instruction for the micro computer 112 to shift from an operating mode to a menu setup mode.

By pressing the MENU switch 113, a menu non-display state can be shifted to a menu display state, or the menu display state can be shifted to the menu non-display state.

The UP switch 114, the DOWN switch 115, the LEFT switch 116 and the RIGHT switch 117 are for entering instructions for the vertical and horizontal movement of a cursor in the menu setup mode.

When a sync signal for an analog RGB signal is detected by the A/D converter 101, the A/D converter 101 converts the analog RGB signal and outputs the resultant signal as a digital RGB signal 101a.

During the analog/digital conversion, analog levels regarded as black and white levels are determined by setting an offset and a gain.

It should be noted that the offset and gain can be designated by the micro computer 112 through communication performed via the bus 109.

Furthermore, when the video decoder 102 detects a sync signal for a composite video signal, the video decoder 12 decodes the composite video signal and outputs the resultant signal as a digital YUV signal 102a.

During the video decoding process, brightness and contrast are adjusted through communication performed with the micro computer 112 via the bus 109.

In the explanation given for this exemplary embodiment, an analog RGB signal and a composite video signal can be employed. However, many other signals can be used in the exemplary embodiments for example, a component YcbCr signal, another type of video signal or an IEEE 1397 Standard AV signal can also be employed.

The digital RGB signal output 101a by the A/D converter 101 and the digital YUV signal output 102a by the video decoder 102 are transmitted to the selector 103.

In accordance with an instruction received from the micro computer 112, the selector 103 selectively outputs either the digital RGB signal or the digital YUV signal.

The matrix operating circuit 104 performs a matrix operation for a received signal, i.e., performs a transformation of the color space and an adjustment of the contrast, hues and densities of colors.

The obtained signal is transmitted as a digital RGB signal 104a to the scaler 106 via the frame buffer 105.

When the digital YUV signal 102a is output to the selector 103, the setup for the color space transformation of the YUV space into the RGB space is designated in accordance with an instruction received from the micro computer 112.

The scaler 106 performs an expansion/reduction process and a keystone correction process for an input video signal, and outputs the resultant video signal (e.g., digital RGB signal 106a) to the OSD circuit 107.

The OSD circuit 107 overlays the input video signal with an OSD (On Screen Display) picture, (e.g., a menu picture), and outputs the obtained signal to the light valve drive circuit 108.

The light valve drive circuit 108 converts the received video signal into a light valve drive signal 108a that permits a light valve (not shown) to generate a video signal, and outputs the light valve drive signal.

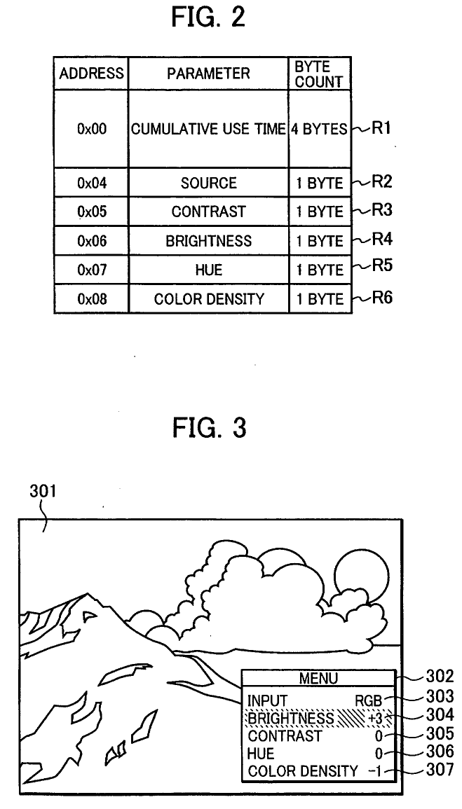

FIG. 2 illustrates a diagram showing the memory map of the NVRAM 118. Data that are stored in the NVRAM 118 can be used by the micro computer 112.

An area R1 is an area wherein cumulative use time is recorded, and for this, four bytes are prepared. At the factory shipping time, the entry in the area R1 is 0, but while the video display apparatus (e.g., liquid crystal projector) is being operated, the value in the area R1 is incremented by one, each minute, by the micro computer 112.

An area R2 is a one byte area wherein data indicating an input source are stored.

The input sources for at least one exemplary embodiment can vary, for example the analog RGB signal and the composite video signal described above. Unique IDs are prepared, and the IDs are displayed in the area R2 for the input sources that are stored.

Furthermore, when the video display apparatus (e.g., liquid crystal projector) is activated, or when the setup of the menu screen, which will be described later, is changed, the micro computer 112, to select an appropriate input source, changes the setup of the selector 103 in accordance with the area R2.

An area R3 is the area of one byte wherein data indicating a contrast are stored, and in at least one exemplary embodiment, a value can be stored that ranges from −128 to +127.

An area R4 is the area of one byte wherein data indicating brightness are stored, and in at least one exemplary embodiment, a value can be stored that ranges from −128 to +127.

An area R5 is the area of one byte wherein data indicating a hue are stored, and in at least one exemplary embodiment, a value can be stored that ranges from −128 to +127.

An area R6 is the area of one byte wherein data indicating the density of a color are stored, and in this embodiment, a value can be stored that ranges from −128 to +127.

In at least one exemplary embodiment, when the MENU switch 113 is pressed while the menu screen is not displayed, the micro computer 112 outputs a menu picture overlay instruction to the OSD circuit 107 and the menu screen then appears.

When the MENU switch 113 is pressed while the menu is displayed, the menu disappears.

FIG. 3 illustrates a diagram showing an example wherein the menu is displayed.

A background picture 301 is a picture indicated by an analog RGB signal or a composite signal input to the video display apparatus (e.g., liquid crystal projector) in at least one exemplary embodiment.

Five choices, i.e., an input 303, a brightness 304, a contrast 305, a hue 306 and a color density 307, are provided on a menu screen 302. In further exemplary embodiments, more or less menu choices can be displayed and are not limited to the five shown.

In FIG. 3, a cursor is positioned at brightness 304, and can be moved to a lower or an upper choice by pressing the DOWN switch 115 or the UP switch 114.

When at this time a LEFT switch 116 or a RIGHT switch 117 is pressed, an instruction for changing the setup in consonance with the position of the cursor is transmitted to the micro computer 112.

When the cursor is located at input 303, either an analog RGB signal or a composite video signal is to be set, and “RGB” and “VIDEO” setup values are present in the menu 302. Note that in other exemplary embodiments the number of inputs can vary and are not limited to the two mentioned in the illustrative examples (e.g., analog RBG signal and composite video signal).

At this time, the two setup values are switched by pressing the LEFT switch 116 and the RIGHT switch 117, and contemporaneously with when the display is changed, a selected value is entered in the area R2 of the NVRAM 118.

The brightness 304, the contrast 305, the hue 306 and the color density 307 are choices used to perform corresponding video adjustments on the background screen 301.

By using the LEFT switch 116 and the RIGHT switch 117, the setup values for the contrast, the hue and the color density can be changed (e.g., within a range of from −128 to +127 in at least one exemplary embodiment).

When changed, updated values are entered in the areas R3, R4, R5 and R6 of the NVRAM 118.

When a new signal is detected, or when a setup value is changed on the menu, parameters for brightness, contrast, hue and color density are set in their individual blocks by the micro computer 112, and an adjustment based on the updated values is performed.

For the setup of the brightness and the contrast, the micro computer 112 employs the data in areas R3 and R4 of the NVRAM 118, and when these data are analog RGB input data, sets the brightness and the contrast for the A/D converter 101.

Otherwise, when the data are composite input data (e.g., from a composite video signal), the brightness and contrast are set for the video decoder 102.

For the setup of the hue and the color density, the micro computer 112 employs the data in areas R5 and R6 in the NVRAM 118 and designates the hue and the color density for the matrix operating circuit 104.

In at least one exemplary embodiment, a characteristic of the A/D converter 101 is that when a sampling clock differs, an offset consonant with the sampling offset is carried by a digital signal obtained by the conversion of the identical analog signal.

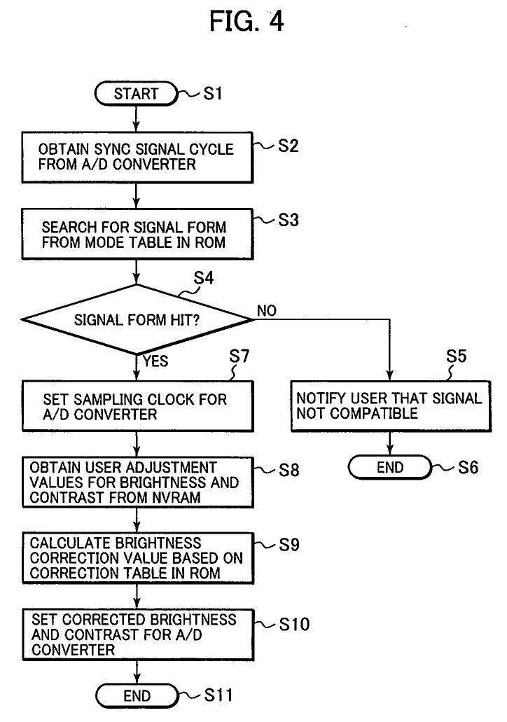

While referring to FIG. 4, a detailed explanation will now be given for the sequential processing performed by the micro computer 112 of at least one exemplary embodiment following the reception of the analog RGB signal.

First, when the micro computer 112 finds that the A/D converter 101 has detected a new signal, or when a user has changed the input setup, the processing is initiated at Si.

At S2, the micro computer 112 obtains, through communication performed via the bus 109, the cycle of a sync signal for an analog RGB signal detected by the A/D converter 101.

At S3, the micro computer 112 detects a signal form based on the interval for the obtained sync signal.

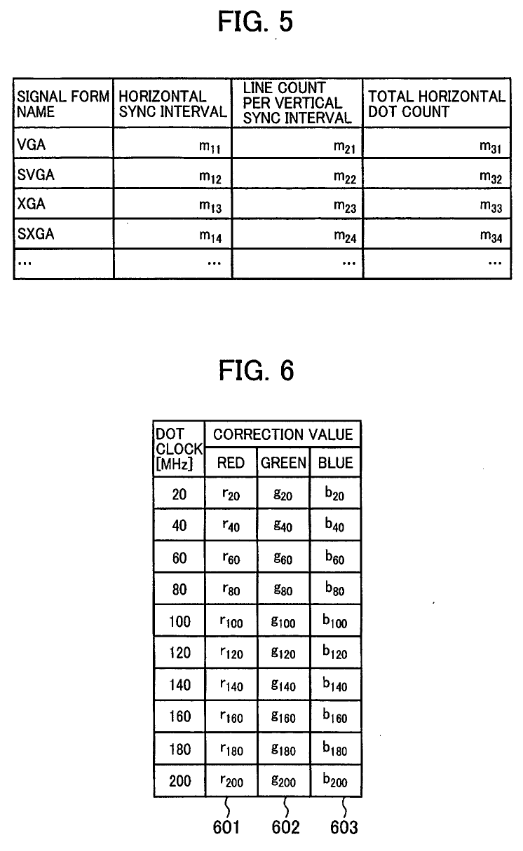

For this detection process, a method is employed whereby a similar signal form, based on a table shown in FIG. 5, is obtained by employing, as a key, the number of horizontal lines within a vertical sync interval.

At S4, a check is performed to determine whether a signal form similar to a signal having the sync signal cycle obtained at S1 is present in the table in FIG. 5.

At S5, a process is performed when a valid signal form is not found at S3.

That is, the user is notified that an input signal is not compatible with the video display apparatus (e.g., liquid crystal projector). Specifically, a warning message is issued through the OSD, and thereafter, at S6, the processing sequence is terminated.

At S7, a sampling clock is calculated in accordance with the signal form obtained at S3, and the A/D converter 101 is set up.

At S8, the adjustment values on the menu for brightness and contrast are obtained based on the data in the areas R5 and R6 of the NVRAM 118.

At S9, a table in the ROM 110, shown in FIG. 6, wherein a correlation between the sampling clock and the correction value for brightness is entered, is examined, and a correction value is calculated in accordance with the sampling clock obtained at S7.

In FIG. 6, a correction value 601 for red brightness, a correction value 602 for green brightness and a correction value 603 for blue brightness are defined in advance for a dot clock (e.g., every 20 MHz), and through linear interpolation, based on the sampling clock, three correction values are obtained.

In this case, the sampling clock and the offset are quantized by calibrating the A/D converter 101 in advance, and a value for correcting or reducing the error of the quantization value is employed as a constant for a table (e.g., the one in FIG. 6).

In at least one exemplary embodiment, a method for referring to the table has been explained. However, in another method in accordance with at least one exemplary embodiment, the characteristic of the A/D converter 101 can be approximated (e.g., by using a function), and thereafter, computation can be used to calculate a correction value.

At S10, the sum of the brightness correction values obtained at S9 and the brightness adjustment values at S8 is set as an offset value for the A/D converter 101.

After the gain setup has been performed (e.g., by using the contrast adjustment value obtained at S8), the processing is terminated at S11.

In at least one exemplary embodiment, the offset can be corrected or the error due to the offset reduced. However, when an A/D converter provides different results in the white level, depending on the sampling clock that is employed, naturally, a correction to or a reduction of error in the gain can also be performed.

In this case, a table like the one shown in FIG. 6 can be prepared for the contrast, and at S9, the contrast correction value can be calculated based on the table and employed, at S10, as a gain.

Furthermore, depending on the characteristic of the A/D converter, the two correction values for the offset and the gain can be employed together.

Further, at least one exemplary embodiment can be applied for the A/D converter incorporated in the video decoder 102.

### Second Exemplary Embodiment

As a second exemplary embodiment, the error reduction performed in the first exemplary embodiment is changed for performance by the matrix operating circuit 104 at the following stage.

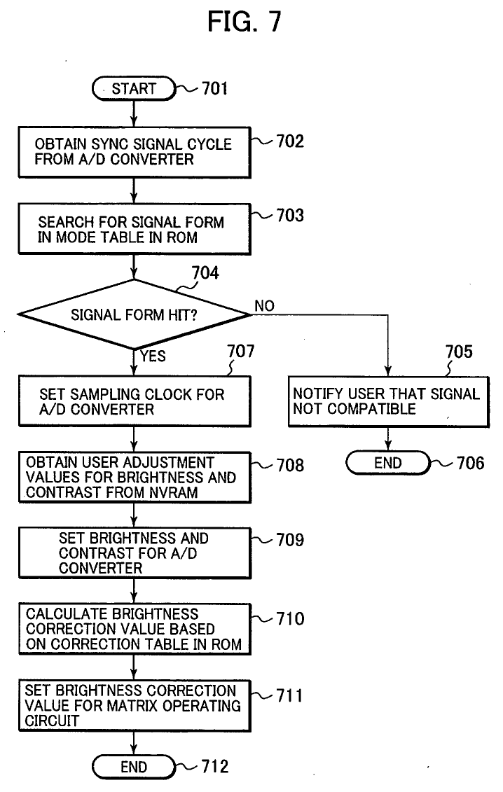

In this case, while referring to FIG. 7 instead of to FIG. 4, the processing sequence for an input analog RGB signal is performed by the micro computer 112.

Steps 701 to 708 are the same as S1 to S8.

In step 709, the brightness and contrast are set for the A/D converter 101, without error reduction or correcting the user adjustment values for the brightness and the contrast.

Step 710 is the same as S9.

In step 711, the micro computer 112 designates for the matrix operating circuit 104, via the bus 109, the brightness correction value obtained in step 710. The processing is thereafter terminated in step 712.

Thereafter, when the analog RGB input is changed to obtain the composite video input, the micro computer 112 sets the matrix operating circuits 104 to transform the YUV color space into RGB color space, and also designates the cancellation of brightness correction.

For the second exemplary embodiment, the correction or error reduction performed by the matrix operating circuit 104 has been described.

However, a correction for or error reduction of the contrast can also be performed when an A/D converter that provides different results for the white levels, depending on the sampling clock that is employed.

In this case, a table (e.g., the one shown in FIG. 6) can be prepared for the contrast, and the contrast correction value can be calculated as in step 710, based on the table, and employed as in step 711.

Furthermore, depending on the characteristic of the A/D converter, the two correction values for the brightness and contrast can be employed together.

In addition, at least one exemplary embodiment can also be applied for the A/D converter incorporated in the video decoder 102.

The matrix operating circuit can be employed for the above two exemplary embodiments. However, exemplary embodiments are not limited to this circuit, and another circuit, (e.g., a linear operating circuit or a lookup table), can be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Laid-Open No. 2004-338925, filed Nov. 24, 2004, which is hereby incorporated by reference herein in its entirety.

What is claimed is:

1. A video display apparatus comprising:
an A/D converter configured to convert an input analog video signal into a digital video signal and outputting the digital video signal;
a sync signal detector configured to detect a sync signal of the input analog video signal;
a signal processor, configured to process the digital video signal obtained from the A/D converter;
a sampling clock determination unit configured to determine a sampling clock;
a sampling parameter determination unit configured to determine a sampling parameter;
a signal processing parameter determination unit configured to determine a signal processing parameter;
a first notification unit configured to notify the A/D converter of the sampling clock and the sampling parameter; and
a second notification unit configured to notify the signal processor of the signal processing parameter,
wherein at least either the sampling parameter or the signal processing parameter is determined in accordance with a frequency of the sampling clock.

2. A video display apparatus according to claim 1, wherein the sampling parameter includes at least either a gain or an offset used for A/D conversion.

3. A video display apparatus according to claim 1, wherein the signal processor includes a brightness adjustment processor and the signal processing parameter includes a brightness value.

4. A video display apparatus according to claim 1, wherein the signal processor includes a contrast adjustment processor and the signal processing parameter includes a contrast value.

5. A video display apparatus comprising:
a video decoder configured to convert an input composite video signal into a digital YUV signal and outputting the digital YUV signal;
a sync signal detector configured to detect a sync signal of the input analog video signal;
a signal processor, configured to process the digital YUV signal obtained from the video decoder;
a matrix operating circuit configured to transform the YUV color space of the digital YUV signal into RGB color space;
a sampling clock determination unit configured to determine a sampling clock;
a sampling parameter determination unit configured to determine a sampling parameter;
a signal processing parameter determination unit configured to determine a signal processing parameter;
a first notification unit configured to notify the video decoder of the sampling clock and the sampling parameter; and
a second notification unit configured to notify the signal processor of the signal processing parameter,
wherein at least either the sampling parameter or the signal processing parameter is determined in accordance with a frequency of the sampling clock.

6. A video display apparatus according to claim 5, wherein the sampling parameter includes at least either a gain or an offset used for the video decoder.

7. A video display apparatus according to claim 5, wherein the signal processor includes a brightness adjustment processor and the signal processing parameter includes a brightness value.

8. A video display apparatus according to claim 5, wherein the signal processor includes a contrast adjustment processor and the signal processing parameter includes a contrast value.

9. The video display apparatus according to claim 8, wherein the contrast is calculated by using a table of values.

10. The video display apparatus according to claim 5, wherein a linear operating circuit replaces the matrix operating circuit.

11. The video display apparatus according to claim 5, wherein the matrix operating circuit uses a lookup table.

12. A video display apparatus according to claim 4 or claim 8, wherein the contrast value is calculated using a look-up table.
